(19) United States
(12) Patent Application Publication
(10) Pub. No.: US 2026/0153372 A1
(43) Pub. Date: Jun. 4, 2026

(54) CORIOLIS FLOW METER

(71) Applicant: Endress+Hauser Flowtec AG, Reinach (CH)

(72) Inventors: Rémy Scherrer, Oberdorf (FR); Daniel Richner, Rheinfelden (CH)

(21) Appl. No.: 19/133,915

(22) PCT Filed: Nov. 15, 2023
(86) PCT No.: PCT/EP2023/081893

§ 371 Date: May 29, 2025

(30) Foreign Application Priority Data
Nov. 30, 2022 (DE) 10 2022 131 692.0
Aug. 3, 2023 (DE) 10 2023 120 583.8

(51) Int. Cl. G01F 1/84

(52) U.S. Cl. CPC G01F 1/8436; G01F 1/8422; G01F 1/8427; G01F 1/8431

(57) ABSTRACT

A Coriolis flow meter includes a sensor system generating a first sensor signal and a second sensor signal. A measuring or operating circuit includes a microprocessor designed to operate an excitation system. An all-pass filter having a filter coefficient and which is designed to receive the first sensor signal and to generate a filtered first sensor signal is provided. The measuring or operating circuit receives the filtered first sensor signal and the second sensor signal, and has a control circuit designed to control the filter coefficient, based on the filtered first sensor signal and the second sensor signal, or based on a variable derived from the filtered first sensor signal and the second sensor signal, such that a control criterion is satisfied, and a first measurement value representing the process variable from the filter coefficient is generated.

The invention relates to a Coriolis flow meter for determining a time-varying process variable of a flowable medium.

Process measurement technology field devices with a sensor of the vibration type and especially Coriolis flow meters have been known for many years. The basic structure of such a measuring device is described in, for example, EP 1 807 681 A1, wherein reference is made in full to this publication with respect to the structure of a generic field device in the context of the present invention.

Typically, Coriolis flow meters have at least one or more vibratable measuring tubes which can be set into vibration by means of a vibration exciter. These vibrations are transmitted along the tube length and are varied by the type of flowable medium located in the measuring tube and by its flow rate. At another point in the measurement tube, an oscillation sensor or, in particular, two oscillation sensors spaced apart from one another can record the varied oscillations in the form of a sensor signal or a plurality of sensor signals. A measuring and/or operating circuit can then determine the mass flow, the viscosity, and/or the density of the flowing medium from the sensor signal(s).

To determine the mass flow \dot{m}, it is common to use the following formula:

$$\dot{m} = k \cdot tan ( Δφ / 2 ) / 2 π f$$

f is the driver frequency of the excitation signal, Δφ the phase difference between two measured sensor signals, and k a calibration factor. With this approach, the mass flow can be determined very accurately for stable flow rates. The disadvantage is that, under disturbed conditions—such as those that occur in multiphases in the medium—and thus with a temporally unstable driver frequency and amplitude, the measuring system is no longer in a harmonic operating mode, and the above formula is no longer sufficiently accurate, or even invalid. Furthermore, a time offset between the determined phase difference Δφ and the driver frequency f may come about, i.e., the driver frequency f assumed for the measured value of the process variable does not match the actual driver frequency f present at the time of measuring the sensor signals for determining the phase difference Δφ. This leads to a falsification of the determined process variable.

The object of the invention is thus to remedy this problem.

The object is achieved by the Coriolis flow meter according to claim 1 and the Coriolis flow meter according to claim.

The Coriolis flow meter according to the invention for determining a time-varying process variable of a flowable medium, comprising:
a measuring tube for conducting the medium;
an excitation system for inducing mechanical oscillations of the measurement tube;
a sensor system for detecting the mechanical oscillations of the measurement tube,
   wherein the sensor system is configured to generate at least a first sensor signal and a second sensor signal,
a measuring and/or operating circuit, in particular formed by at least one microprocessor,
   wherein the measuring and/or operating circuit is configured to operate the excitation system with an excitation signal,
   wherein the measuring and/or operating circuit comprises an adaptive filter, in particular an all-pass filter, with a filter coefficient a, which is configured to receive the first sensor signal and to generate a filtered first sensor signal,
   wherein the measuring and/or operating circuit comprises a control circuit configured to receive the filtered first sensor signal and the second sensor signal,
   wherein the control circuit is configured to control the filter coefficient a, based upon the filtered first sensor signal and the second sensor signal, or a variable derived from the filtered first sensor signal and the second sensor signal, so that a control criterion is met,
   wherein the measuring and/or operating circuit is configured to generate, from the filter coefficient a, a first measured value representing the process variable.

This results in the first measured value representing the process variable (e.g., mass flow, viscosity, density) no longer being determined analytically, but being derived from the two sensor signals and the filter coefficient a determined by the control system. By controlling the all-pass filter via the filter coefficient a, for example, such that the filtered first sensor signal matches the second sensor signal within tolerance limits, it is achieved that the information of the first measured value representing the process variable is projected onto the filter coefficient a. Thus, the filter coefficient a describes the influence of the process variable to be determined on the sensor signal and is therefore proportional to it. If the first measured value representing the process variable is determined as a function of the filter coefficient a, not only is the measurement error reduced, but also the need for precisely timed synchronization of the driver frequency f with the phase difference Δφ. This prevents dynamic zero point shifts from occurring in the event of strong frequency fluctuations.

Advantageous embodiments of the invention are the subject matter of the dependent claims.

One embodiment provides that the control circuit be configured to determine the filter coefficient a by means of a least mean squares algorithm and/or a recursive least squares algorithm.

The control circuit is preferably located close to the sensor system, so that the sensor signal travels only a short distance to the control circuit. Furthermore, the sensor signal is preferably provided to the control circuit immediately after generation, so that there is no time delay that would otherwise occur if the sensor signal first had to pass through the electronic components to form the phase difference.

One embodiment provides that the control circuit comprise a PID controller which is configured to control the filter coefficient a, based upon the filtered first sensor signal and the second sensor signal or the variable derived from the filtered first sensor signal and the second sensor signal, so that the control criterion is met.

One embodiment provides that the process variable comprise the mass flow of the medium.

One embodiment provides that the excitation signal have a driver frequency f,
wherein the driver frequency f is not included in the determination of the first measured value representing the process variable, in particular the mass flow, of the medium.

One embodiment provides that the control criterion comprise that a deviation between the filtered first sensor signal and the second sensor signal assume a sensor signal setpoint or be smaller than a sensor signal limit value.

One embodiment provides that the measuring and/or operating circuit be configured to detect a phase difference Δφ between the filtered first sensor signal and the second sensor signal,
wherein the derived quantity corresponds to the phase difference Δφ.

One embodiment provides that the control criterion comprise that the phase difference Δφ correspond to a phase difference setpoint and/or less than a phase difference limit.

One embodiment provides that, additionally, a calibration factor k, which is in particular determined at the factory, be included in the generation of the first measured value representing the process variable, in particular the mass flow.

One embodiment provides that the measuring and/or operating circuit be designed to determine from the filter coefficient a and optionally output a current process status.

One embodiment provides that the current process status comprise the presence of gas bubbles in the medium.

One embodiment provides that the measuring and/or operating circuit be configured:
in a first operating mode, to determine and output a second measured value representing the process variable as a function of a phase difference Δφ between the first sensor signal or the filtered first sensor signal and the second sensor signal and the driver frequency f,
in a second operating mode, to determine and output the first measured value representing the process variable as a function of the filter coefficient a.

One embodiment provides that the measuring and/or operating circuit be configured to switch from the first operating mode to the second operating mode when a deviation between the first measured value and the second measured value assumes a setpoint and/or lies outside a tolerance range.

One embodiment provides that the measuring and/or operating circuit be configured to determine the presence of gas bubbles by comparing the first signal and the second signal.

One embodiment provides that the measuring and/or operating circuit be configured:
to determine a second measured value representing the process variable, in particular the mass flow, as a function of a phase difference Δφ between the filtered first sensor signal or first sensor signal and the second sensor signal and the driver frequency f,
to correct the second measured value as a function of the filter coefficient a or the first measured value, and
to output the corrected second measured value.

One embodiment provides that the all-pass filter be designed such that the mathematical relationship between the first sensor signal and the filtered first sensor signal can be described via a transfer function H(s)=(1−a·s)/(1+a·s) with a Laplace index s.

The Coriolis flow meter according to the invention for determining a time-varying process variable of a flowable medium, comprising:
a measuring tube for conducting the medium;
an excitation system for inducing mechanical oscillations of the measurement tube;
a sensor system for detecting the mechanical oscillations of the measurement tube,
   wherein the sensor system is configured to generate at least a first sensor signal and a second sensor signal,
a measuring and/or operating circuit, in particular formed by at least one microprocessor,
   wherein the measuring and/or operating circuit is designed to operate the excitation system with an excitation signal,
   wherein the measuring and/or operating circuit comprises a first adaptive filter with a filter coefficient a, which is configured to receive the first sensor signal and to generate a filtered first sensor signal,
   wherein the measuring and/or operating circuit (5) comprises a second adaptive filter with a filter coefficient b, which is configured to receive the second sensor signal s2 and to generate a filtered second sensor signal s2*,
   wherein the measuring and/or operating circuit comprises a control circuit configured to receive the filtered first sensor signal s1* and the filtered second sensor signal s2*, or a variable derived from the filtered first sensor signal s1* and the filtered second sensor signal s2*,
   wherein the control circuit is configured to control the filter coefficient a and/or the filter coefficient b, based upon the filtered first sensor signal s1* and the filtered second sensor signal s2*, or a variable derived from the filtered first sensor signal s1* and the filtered second sensor signal s2*, so that a control criterion is met,
   wherein the measuring and/or operating circuit is configured to generate, from the filter coefficient a and/or from the filter coefficient b, a first measured value representing the process variable.

This results in the first measured value representing the process variable (e.g., mass flow, viscosity, density) no longer being determined analytically, but being derived from the two sensor signals and the filter coefficients a and/or b determined by the control system. By controlling the adaptive first filter via the filter coefficient a and the adaptive second filter via the filter coefficient b, for example, such that the filtered first sensor signal s1* matches the filtered second sensor signal s2* within tolerance limits, it is achieved that the information of the first measured value representing the process variable is projected onto the filter coefficients a and/or b. The filter coefficient a and/or the filter coefficient b thus describes or describe the influence of the process variable to be determined on the sensor signal and is or are therefore proportional to it. If the first measured value representing the process variable is determined as a function of the filter coefficient a and/or the filter coefficient b, not only is the measurement error reduced, but also the need for precisely timed synchronization of the driver frequency f with the phase difference Δφ. This prevents dynamic zero point shifts from occurring in the event of strong frequency fluctuations.

Advantageous embodiments of the invention are the subject matter of the dependent claims.

One embodiment provides that the control circuit be configured to determine the filter coefficient a and/or the filter coefficient b by means of a least mean squares algorithm and/or by means of a normalized least mean squares algorithm and/or by means of a recursive least squares algorithm and/or a linear or non-linear gradient method.

The control circuit is preferably located close to the sensor system, so that the sensor signal travels only a short distance to the control circuit. Furthermore, the sensor signal is preferably provided to the control circuit immediately after generation, so that there is no time delay that would otherwise occur if the sensor signal first had to pass through the electronic components to form the phase difference.

One embodiment provides that the control circuit comprise a PID controller which is configured to control the filter coefficient a and/or the filter coefficient b, based upon the filtered first sensor signal s1* and the filtered second sensor signal s2* or the variable derived from the filtered first sensor signal s1* and the filtered second sensor signal s2*, so that the control criterion is met.

One embodiment provides that the process variable comprise the mass flow of the medium.

One embodiment provides that the excitation signal have a driver frequency f,
wherein the driver frequency f is not included in the determination of the first measured value representing the mass flow of the medium.

One embodiment provides that the control criterion comprise that a deviation between the filtered first sensor signal s1* and the filtered second sensor signal s2* assume a sensor signal setpoint or be smaller than a sensor signal limit value.

One embodiment provides that the measuring and/or operating circuit be configured to detect a phase difference Δφ between the filtered first sensor signal s1* and the filtered second sensor signal s2*,
wherein the derived variable corresponds to the phase difference Δφ.

One embodiment provides that the control criterion comprise that the phase difference Δφ correspond to a phase difference setpoint and/or less than a phase difference limit.

One embodiment provides that, additionally, a calibration factor k, which is in particular determined at the factory, be included in the generation of the first measured value representing the process variable, in particular the mass flow.

One embodiment provides that the measuring and/or operating circuit be configured to determine and optionally output the current process status from the filter coefficient a and/or from the filter coefficient b.

One embodiment provides that the current process status comprise the presence of gas bubbles in the medium.

One embodiment provides that the measuring and/or operating circuit be configured:
in a first operating mode, to determine and output a second measured value representing the process variable as a function of a phase difference Δφ between the first sensor signal or the filtered first sensor signal s1* and the filtered second sensor signal s2* and the driver frequency f,
in a second operating mode, to determine and output the first measured value representing the process variable as a function of the filter coefficient a and/or the filter coefficient b.

One embodiment provides that the measuring and/or operating circuit be configured to switch from the first operating mode to the second operating mode when a deviation between the first measured value and the second measured value assumes a setpoint and/or lies outside a tolerance range.

One embodiment provides that the measuring and/or operating circuit be configured to determine the presence of gas bubbles by comparing a signal representing the first measured value and a signal representing the second measured value.

One embodiment provides that the measuring and/or operating circuit be configured:
to determine a second measured value representing the process variable, in particular the mass flow, as a function of a phase difference Δφ between the filtered first sensor signal s1* or first sensor signal and the filtered second sensor signal s2* or the second sensor signal s2 and the driver frequency f,
to correct the second measured value as a function of the filter coefficient a and/or the filter coefficient b, or the first measured value, and
to output the corrected second measured value.

One embodiment provides that the first filter be designed such that the mathematical relationship between the first sensor signal and the filtered first sensor signal can be described via a transfer function H(s)=(1−a·s) with a Laplace index s.

One embodiment provides that the first filter be designed such that the mathematical relationship between the first sensor signal s1 and the filtered first sensor signal s1* can be described via a transfer function H(s)=(1−a·s)/(1+as) with a Laplace index s.

One embodiment provides that the first filter be designed such that the mathematical relationship between the first sensor signal s1 and the filtered first sensor signal s1* can be described via a transfer function H(s)=(1+a)/2+(1−a)/2·z⁻¹, wherein z is a z-variable of a discrete system.

One embodiment provides that the second filter be designed such that the mathematical relationship between the second sensor signal s2 and the filtered second sensor signal s2* can be described via a transfer function H(s)=(1+b·s) with a Laplace index s.

One embodiment provides that the second filter be designed such that the mathematical relationship between the second sensor signal s2 and the filtered second sensor signal s2* can be described via a transfer function H(s)=(1−b)/2+(1+b)/2·z⁻¹, wherein z is a z-variable of a discrete system.

One embodiment provides that the second filter be designed such that the mathematical relationship between the second sensor signal s2 and the filtered second sensor signal s2* via a transfer function H(s)=½+½*z⁻¹,
wherein z is a z-variable of a discrete system.

One embodiment provides that the second filter be designed such that the mathematical relationship between the second sensor signal s2 and the filtered second sensor signal s2* can be described via a transfer function H(s)=1.

One embodiment provides that a=b must be satisfied.

One embodiment provides that the first adaptive filter and/or the second adaptive filter, in particular each, be an all-pass filter.

The invention is explained in greater detail with reference to the following figures, in which:

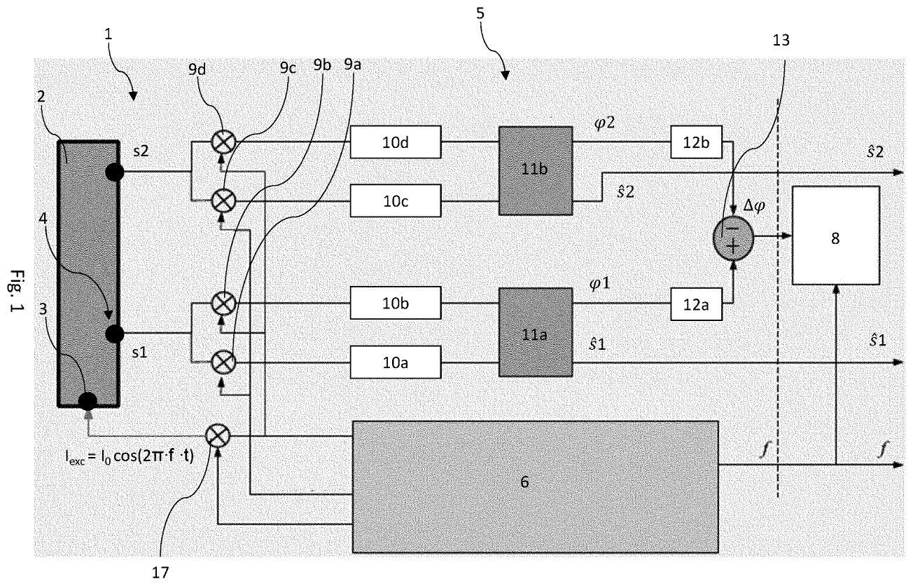

FIG. 1 shows a diagram of a Coriolis volumetric flow meter according to the prior art;

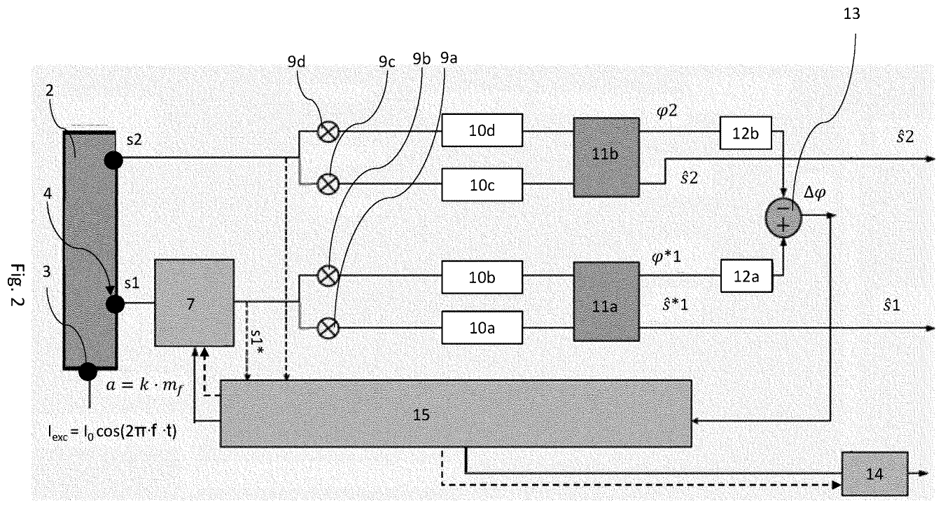

FIG. 2 shows a diagram of two embodiments of the Coriolis flow meter according to the invention; and

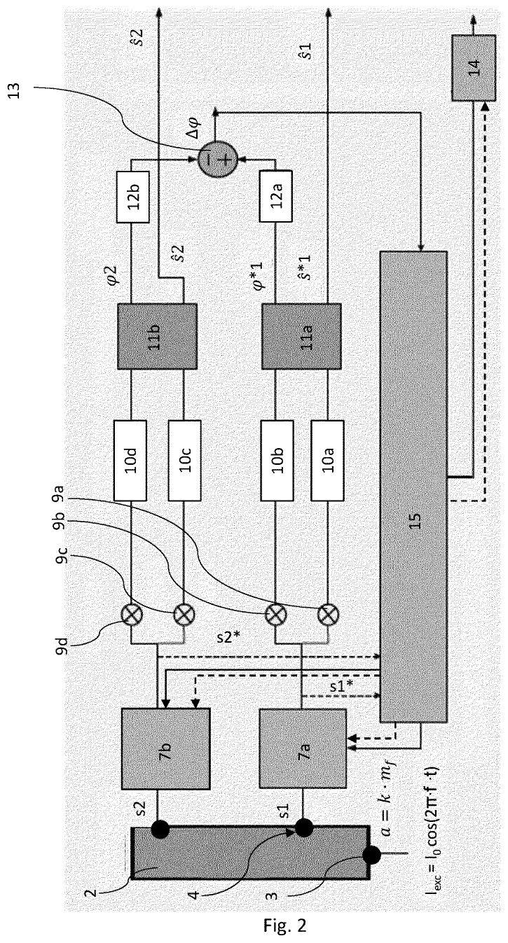

FIG. 3 shows another diagram of two embodiments of the Coriolis flow meter according to the invention.

FIG. 1 shows a diagram of a Coriolis flow meter 1 according to the prior art. The Coriolis flow meter 1 for determining a time-varying process variable of a flowable medium comprises a measurement tube 2 for guiding the medium. Exactly one straight measurement tube 3 is shown. However, the use of curved and/or multiple measurement tubes is already known. The core idea of the invention can be applied to any shape and number of measurement tubes.

An excitation system 3 for inducing mechanical oscillations of the measurement tube 2 interacts with the measurement tube 2. One or more excitation coils per measurement tube are suitable for this purpose, which are arranged, by means of a holding device on the measurement tube, in the housing of the Coriolis flow meter or in a specially designed arrangement inside the housing. The excitation coil usually interacts with a magnet arranged directly on the measurement tube or via a holding device. However, other excitation systems are also known. Thus, the excitation system may also be in mechanical contact with the measurement tube 2 and be designed and configured to transfer its own oscillation behavior to the measurement tube 2. However, the nature of the excitation system 3 is not essential to the invention.

The Coriolis flow meter 1 further comprises a sensor system 4 for detecting the mechanical oscillations of the measurement tube 2. The sensor system 4 typically comprises two sensor coils per measurement tube, each of which interacts with a magnet arranged on the measurement tube 2. The sensor coils may—like the excitation coils—be arranged, by means of a holding device on the measurement tube 2, in the housing (not shown) of the Coriolis flow meter 1 or in an arrangement provided for this purpose (not shown) inside the housing. The sensor coils are usually arranged offset from each other in the flow direction of the medium. The excitation coil is arranged between the two sensor coils in the flow direction of the medium. However, different sensor systems are also known. The mechanical oscillations of the measurement tube 2 can also be detected using optical sensors. The nature of the sensor system 4 is not essential to the invention. The sensor system 4 is configured to generate at least a first sensor signal s1 and a second sensor signal s2, wherein the first sensor signal s1 and the second sensor signal s2 describe the current oscillation behavior of the measurement tube 2 at two different positions offset in the flow direction.

In the illustrated embodiment, the sensor system 4 comprises two sensor coils, and the excitation system comprises one excitation coil. The positioning of the two sensor coils and the excitation coil is chosen for the purpose of a clearer representation of the diagram and does not correspond to an actually necessary arrangement. The first sensor signal s1 is provided to one of the two sensor coils, and the second sensor signal s2 is provided to the corresponding other sensor coil.

The excitation system 3 and the sensor system 4 are connected to a measuring and/or operating circuit 5, in particular comprising at least one microprocessor and electronic components (for example, comprising a transistor, an electrical resistor, a capacitor, a mixer, a filter, and/or a microcontroller). In the illustrated embodiment, the measuring and/or operating circuit 5 comprises a control unit 6 which is configured to provide an excitation signal with a driver frequency f and an excitation amplitude I₀, and thus operate the excitation system. In the illustrated embodiment, the excitation signal can be described by I_{exc}=I₀·cos(2πft), wherein the excitation amplitude is a maximum excitation coil current and I_{exc} the time-dependent, current excitation coil current. The driver frequency f and the excitation amplitude I₀ are adjustable variables. The control unit 6 is designed to provide the excitation amplitude I₀ and the time-varying (periodic) part of the excitation signal—in the form of cos(2πft)—to a mixer 16, which creates the excitation signal from the two parts and forwards this to the excitation system 3. Furthermore, the control unit 6 is electrically connected to four further mixers 9a-d. The control unit 6 is designed to provide a cos(2πft) signal at the mixers 9a, 9c and a sin(2πft) signal at the mixers 9b, 9c. Furthermore, the control unit 6 is configured to transmit the current driver frequency f to a computing unit 8. The computing unit 8 is also part of the measuring and/or operating circuit 5 and is configured to determine the mass flow mt at least as a function of the provided driver frequency f. The driver frequency f is output or is included in determining further process variables.

The first sensor signal s1 can be described by s1=ŝ1−cos(2πft+φ₁). φ₁ is the first phase, and s1 is the first signal amplitude. The first sensor signal s1 is transmitted to the, in particular multiplicative, mixers 9a, 9b for frequency conversion. The mixer 9a is configured to apply a sine component to the first sensor signal s1. For example, the mixer 9a may be configured to multiply the first sensor signal s1 by a sine function sin(2πft). The mixer 9b is configured to apply a cosine component to the first sensor signal s1. Thus, the mixer 9b may be configured to multiply the first sensor signal s1 by a cosine function cos(2πft). The result of the two mixers 9a, 9b is in each case provided to a filter 10a, 10b. The filters 10a, 10b may, for example, be low-pass filters. These may be configured to eliminate the 2f component of the sensor signal. Furthermore, the filters 10a, 10b are configured to limit the bandwidth of the incoming sensor signal in order to reduce the noise component. The filtered results are provided to a computing unit 11a which is suitable and configured to execute an algorithm. The algorithm may, for example, be an iterative algorithm, in particular a coordinate rotation digital computer algorithm, with which mathematical functions can be executed. The algorithm is designed and configured to determine the first phase φ₁ and the first signal amplitude ŝ1. The first signal amplitude s1 may be output or used to determine another process variable.

The second sensor signal s2 can be described by s2=ŝ2·cos(2πft+φ₂). φ₂ is the second phase and s2 the second signal amplitude. In flowing medium, the second phase φ₂ is offset from the first phase φ₁ by a phase difference Δφ. The second sensor signal s2 is transmitted to the, in particular multiplicative, mixers 9c, 9d. The mixer 9c is configured to apply a sine component to the second sensor signal s2. For example, the mixer 9a may be configured to multiply the second sensor signal s2 by a sine function sin(2πft). The mixer 9b is configured to apply a cosine component to the second sensor signal s2. Thus, the mixer 9b may be configured to multiply the second sensor signal s2 by a cosine function cos(2πft). The result of the two mixers 9c, 9d is in each case provided to a filter 10c, 10d. The filters 10c, 10d may, for example, be low-pass filters. The filtered results are provided to a computing unit 11b, which is configured to execute an algorithm. The algorithm may, for example, be an iterative algorithm, in particular a coordinate rotation digital computer algorithm, with which mathematical functions can be executed. The algorithm is designed and configured to determine the second phase φ₂ and the second signal amplitude s2. The second signal amplitude s2 can be output or used to determine another process variable. The first phase φ₁ and the second phase φ₂ are each provided to a filter 12a, 12b. The filters 12a, 12b are configured to reduce the respective noise components of the determined phases. The filters 12a, 12b may, for example, be low-pass filters.

The measuring and/or operating circuit 15 further has a subtractor 13. The first phase cp, and the second phase φ₂ are entered into the subtractor 13. The subtractor 13 is configured to determine the phase difference Δφ—which is proportional to the mass flow \dot{m}—between the first phase φ₁ and the second phase φ₂ and provide it to a computing unit 8. The computing unit 8 is configured to determine the mass flow m as a function of the phase difference Δφ and the provided driver frequency f. The mass flow \dot{m} is determined based upon the equation \dot{m}=k·tan(Δφ/2)/2πf.

FIG. 2 shows a diagram of two Coriolis flow meters according to the invention. The first embodiment is shown by the dashed lines and the second embodiment by the solid lines.

According to the first embodiment, the first sensor signal s1 is provided to an all-pass filter 7. An all-pass filter 7 is a signal processing filter that passes all frequencies equally, but changes the phase relationship between the different frequencies. The all-pass filter 7 is configured to receive the first sensor signal s1 and to generate a filtered first sensor signal s1*. The transfer function H(s) with which the first sensor signal s1 is converted into the filtered first sensor signal s1* must satisfy H(s)=(1−a·s)/(1+a·s). s is the Laplace index.

The measuring and/or operating circuit 5 has a control circuit 15 which is configured to control the filter coefficient a, based upon the filtered first sensor signal s1* and the second sensor signal s2, or a variable derived from the filtered first sensor signal s1* and the second sensor signal s2, so that a control criterion is met. The control criterion can be a deviation between the filtered first sensor signal s1* and the second sensor signal s2, which has to assume a sensor signal setpoint or which has to be smaller than a sensor signal limit value. According to the invention, the control circuit 15 may be configured to determine the filter coefficient a by means of a least mean squares algorithm and/or a recursive least squares algorithm. Alternatively, the control circuit 15 may comprise a PID controller which is configured to control the filter coefficient a, based upon the filtered first sensor signal s1* and the second sensor signal s2 or the variable derived from the filtered first sensor signal s1* and the second sensor signal s2, so that the control criterion is met.

The measuring and/or operating circuit 5 comprises a computing unit 14 which is configured to generate, from the filter coefficient a, a first measured value representing the process variable. Additionally, a calibration factor k, which is in particular determined at the factory, is included in the generation of the first measured value representing the process variable, in particular the mass flow. The equation a=k·m_{F} must be satisfied. Thus, the driver frequency f is not included in the determination the first measured value representing the process variable, in particular the mass flow.

Alternatively or additionally, the measuring and/or operating circuit 5, in particular the computing unit 14, may be configured to determine and optionally output the current process status from the filter coefficient a. An example of the process status to be detected is the presence of gas bubbles in the medium.

In the second embodiment, the measuring and/or operating circuit 5 is configured to determine a phase difference Δφ between the filtered first sensor signal s1* and the second sensor signal s2. For this purpose, the first sensor signal s1 is provided to the all-pass filter, where it is filtered. The filtered sensor signal s*1 passes through the mixers 9a, 9b, where it is mixed as described for the prior art. After mixing, the filtered first sensor signal s*1, to which sine component is applied, passes through a filter 10a. The filter 10a is designed to eliminate the 2f component of the mixed sensor signal s*1 and to reduce the noise component.

It is then provided to a computing unit 11a, which is set up to calculate the first signal amplitude ŝ*1 of the filtered first sensor signal. The filtered first sensor signal s*1, to which a cosine component is applied, passes through a filter 10b. The filter 10b, like the filter 10a, is configured to eliminate the 2f component of the mixed sensor signal s*1 and to reduce the noise component. It is then provided to a computing unit 11b, which is configured to process the filtered first phase φ*₁ of the filtered first sensor signal. The filtered first phase φ*₁ further passes through a filter 12a before being provided to a subtractor 13.

To determine the phase difference Δφ, the second sensor signal s2 passes through the mixers 9c, 9d, the filters 10c, 10d, the computing unit 11b, and the filter 12b. The processing of the second sensor signal s2 corresponds to the processing described in the figure description. The determined second phase φ₂ is provided to the subtractor. The subtractor 13 is configured to determine the phase difference Δφ between the filtered first phase φ*₁ and the second phase φ₂ and provide the same to the controller unit 15. The controller unit 15 is configured to control the filter coefficient a so that the phase difference Δφ corresponds to a phase difference setpoint and/or to less than a phase difference limit. In particular, the filter coefficient a is controlled so that the phase difference Δφ is minimal or zero. Also as in the previous embodiment, the computing unit 14 is configured to determine the measured values representing the process variable as a function of the filter coefficient a and a calibration factor k.

A third embodiment combines the processes of the two previous embodiments and groups them into different operating modes. In a first operating mode, a second measured value representing the process variable is determined and optionally output as a function of a phase difference Δφ between the first sensor signal s1 or the filtered first sensor signal s1* and the second sensor signal s2 and the driver frequency f. The second measured value can be the mass flow. In a second operating mode, the first measured value representing the process variable is determined and optionally output as a function of the filter coefficient a. The measuring and/or operating circuit 5 is configured to switch from the first operating mode to the second operating mode when a deviation between the first measured value and the second measured value assumes a setpoint and/or lies outside a tolerance range. The second measured value can be corrected as a function of the filter coefficient a or the first measured value, and the corrected second measured value can be output.

FIG. 3 shows another diagram of two Coriolis flow meters according to the invention. The third embodiment is shown by the dashed lines and the fourth embodiment by the solid lines.

According to the third embodiment, the first sensor signal s1 is provided to a first adaptive filter 7a. The first filter 7a may be an all-pass filter. The all-pass filter is a signal processing filter that allows all frequencies to pass equally, but changes the phase relationship between the different frequencies. The first filter 7a is configured to receive the first sensor signal s1 and to generate a filtered first sensor signal s1*. The transfer function H(s) with which the first sensor signal s1 is converted into the filtered first sensor signal s1*, must satisfy H(s)=(1−a·s). s is the Laplace index.

Alternatively, the mathematical relationship between the first sensor signal s1 and the filtered first sensor signal s1* can also be expressed via a transfer function H(s)=(1−a·s)/(1+as) with a Laplace index s.

Alternatively, the mathematical relationship between the first sensor signal s1 and the filtered first sensor signal s1* can be expressed via a transfer function H(s)=(1+a)/2+(1−a)/2·z⁻¹. In this case, z is a z-variable of a discrete system.

According to the first embodiment, the second sensor signal s2 is provided to a second adaptive filter 7b. The second filter 7b may also be an all-pass filter. The all-pass filter is a signal processing filter that allows all frequencies to pass equally, but changes the phase relationship between the different frequencies. The second filter 7b is configured to receive the second sensor signal s2 and to generate a filtered second sensor signal s2*. The transfer function H(s), with which the second sensor signal s2 is converted into the filtered second sensor signal s2*, must satisfy H(s)=(1+b·s). s is also the Laplace index.

Alternatively, the mathematical relationship between the second sensor signal s2 and the filtered second sensor signal s2* can be expressed via a transfer function H(s)=(1−b)/2+(1+b)/2·z⁻¹. In this case, z is a z-variable of a discrete system.

Alternatively, the mathematical relationship between the second sensor signal s2 and the filtered second sensor signal s2* can be expressed via a transfer function H(s)=½+½*z⁻¹. In this case, z is a z-variable of a discrete system.

Alternatively, the mathematical relationship between the second sensor signal s2 and the filtered second sensor signal s2* can be expressed via a transfer function H(s)=1.

The measuring and/or operating circuit 5 has a control circuit 15 which is configured to control the filter coefficient a and/or the filter coefficient b, based upon the filtered first sensor signal s1* and the filtered second sensor signal s2*, or a variable derived from the filtered first sensor signal s1* and the filtered second sensor signal s2*, so that a control criterion is met. The control criterion can be a deviation between the filtered first sensor signal s1* and the filtered second sensor signal s2*, which has to assume a sensor signal setpoint or which has to be smaller than a sensor signal limit value. According to the invention, the control circuit 15 may be configured to determine the filter coefficient a and/or the filter coefficient b by means of a least mean squares algorithm and/or by means of a normalized least mean squares algorithm and/or by means of a recursive least squares algorithm and/or a linear or non-linear gradient method.

Alternatively, the control circuit 15 may comprise a PID controller which is configured to control the filter coefficient a and/or the filter coefficient b, based upon the filtered first sensor signal s1* and the filtered second sensor signal s2*, or the variable derived from the filtered first sensor signal s1* and the filtered second sensor signal s2*, so that the control criterion is met.

The measuring and/or operating circuit 5 comprises a computing unit 14 which is configured to generate, from the filter coefficient a and/or the filter coefficient b, an initial measured value for the current mass flow through the pipe. Additionally, a calibration factor k, which is determined, in particular at the factory, is included in the determination of the first measured value representing the mass flow. The equation a=k·m_{F} or b=k·m_{F} must be satisfied. Thus, the driver frequency f is not included in the determination of the first measured value representing the mass flow of the medium.

Alternatively or additionally, the measuring and/or operating circuit 5, in particular the computing unit 14, may be configured to determine, from the filter coefficient a and/or from the filter coefficient b, the current process status and optionally output it. An example of the process status to be detected is the presence of gas bubbles in the medium.

In the fourth embodiment, the measuring and/or operating circuit 5 is configured to determine a phase difference Δφ between the filtered first sensor signal s1* and the filtered second sensor signal s2*. For this purpose, the first sensor signal s1 is provided to the adaptive first filter, where it is filtered. The filtered sensor signal s*1 passes through the mixers 9a, 9b, where it is mixed as described for the prior art. After mixing, the filtered first sensor signal s*1, to which a sine component is applied, passes through a filter 10a. The filter 10a is designed to eliminate the 2f component of the mixed sensor signal s*1 and to reduce the noise component.

It is then provided to a computing unit 11a, which is set up to calculate the first signal amplitude s*1 of the filtered first sensor signal. The filtered first sensor signal s*1, to which a cosine component is applied, passes through a filter 10b. The filter 10b, like the filter 10a, is configured to eliminate the 2f component of the mixed sensor signal s*1 and to reduce the noise component. It is then provided to a computing unit 11b, which is configured to process the filtered first phase φ*₁ of the filtered first sensor signal. The filtered first phase φ*₁ further passes through a filter 12a before being provided to a subtractor 13.

To determine the phase difference Δφ, the second sensor signal s2 is provided to an adaptive second filter 7b, where it is filtered. The filtered sensor signal s*1 passes through the mixers 9c, 9d, the filters 10c, 10d, the computing unit 11b, and the filter 12b. The processing of the filtered second sensor signal s2* corresponds to the processing described in the figure description. The determined second phase φ₂ is provided to the subtractor. The subtractor 13 is configured to determine the phase difference Δφ between the filtered first phase φ*₁ and the second phase φ2 and provide the same to the controller unit 15. The controller unit 15 is configured to control the filter coefficient a so that the phase difference Δφ corresponds to a phase difference setpoint and/or to less than a phase difference limit. In particular, the filter coefficient a and/or the filter coefficient b are controlled so that the phase difference Δφ is minimal or zero. Also as in the previous embodiment, the computing unit 14 is configured to determine the measured values representing the mass flow as a function of the filter coefficient a and/or the filter coefficient b and a calibration factor k.

A third embodiment combines the processes of the two previous embodiments and groups them into different operating modes. In a first operating mode, a second measured value representing the process variable is determined and optionally output as a function of a phase difference Δφ between the first sensor signal s1 or the filtered first sensor signal s1* and the second sensor signal s2 or the filtered second sensor signal s2* and the driver frequency f. The second measured value can be the mass flow. In a second operating mode, the first measured value representing the process variable is determined and optionally output as a function of the filter coefficient a and/or the filter coefficient b. The measuring and/or operating circuit 5 is configured to switch from the first operating mode to the second operating mode when a deviation between the first measured value and the second measured value assumes a setpoint and/or lies outside a tolerance range. The second measured value can be adjusted as a function of the filter coefficient a and/or the filter coefficient b or the first measured value, and the corrected second measured value be output.

### LIST OF REFERENCE SIGNS

1 Coriolis flow meter
2 Measurement tube
3 Excitation system
4 Sensor system
5 Measuring and/or operating circuit
6 Control unit
7 All-Pass filter
8 Computing unit
9i Mixer
10i Filter
11i Computing unit
12i Filter
13 Subtractors
14 Computing unit
15 Control circuit
16 Mixer

1-34. (canceled)

35. A Coriolis flow meter for determining a time-varying process variable of a flowable medium, comprising:
a measuring tube for conducting the medium;
an excitation system for inducing mechanical oscillations of the measurement tube;
a sensor system for detecting the mechanical oscillations of the measurement tube,
wherein the sensor system is configured to generate at least a first sensor signal s1 and a second sensor signal s2,
a measuring or operating circuit including at least one microprocessor,
wherein the measuring or operating circuit is configured to operate the excitation system with an excitation signal,
wherein the measuring or operating circuit comprises an adaptive filter with a filter coefficient a, which is configured to receive the first sensor signal s1 and to generate a filtered first sensor signal s1*,
wherein the measuring or operating circuit comprises a control circuit which is configured to receive the filtered first sensor signal s1* and the second sensor signal s2, or a variable derived from the filtered first sensor signal s1* and the second sensor signal s2,
wherein the control circuit is configured to control the filter coefficient a, based upon the filtered first sensor signal s1* and the second sensor signal s2, or a variable derived from the filtered first sensor signal s1* and the second sensor signal s2, so that a control criterion is met,
wherein the measuring or operating circuit is configured to generate, from the filter coefficient a, a first measured value representing the process variable.

36. The Coriolis flow meter according to claim 35,
wherein the control circuit is configured to adjust the filter coefficient a using a least mean squares algorithm or a recursive least squares algorithm.

37. The Coriolis flow meter according to claim 35,
wherein the control circuit comprises a PID controller which is configured to control the filter coefficient a, based upon the filtered first sensor signal s1* and the second sensor signal s2 or the variable derived from the filtered first sensor signal s1* and the second sensor signal s2, so that the control criterion is met.

38. The Coriolis flow meter according to claim 35,
wherein the control criterion requires that a deviation between the filtered first sensor signal s1* and the second sensor signal s2 matches a sensor signal setpoint or is smaller than a sensor signal limit value.

39. The Coriolis flow meter according to claim 35,
wherein the measuring or operating circuit is configured to detect a phase difference Op between the filtered first sensor signal s1* and the second sensor signal s2,
wherein the derived quantity corresponds to the phase difference Δφ.

40. The Coriolis flow meter according to claim 35,
wherein the measuring or operating circuit is configured to determine from the filter coefficient a the current process status and optionally output it.

41. The Coriolis flow meter according to claim 40,
wherein the measuring or operating circuit is configured:
in a first operating mode, to determine and output a second measured value representing the process variable as a function of a phase difference Δφ between the first sensor signal s1 or the filtered first sensor signal s1* and the second sensor signal s2 and the driver frequency f,
in a second operating mode, to determine and output the first measured value representing the process variable as a function of the filter coefficient a.

42. The Coriolis flow meter according to claim 41,
wherein the measuring or operating circuit is configured to switch from the first operating mode to the second operating mode when a deviation between the first measured value and the second measured value reaches a setpoint or lies outside a tolerance range.

43. The Coriolis flow meter according to claim 42,
wherein the measuring and operating circuit is configured to determine the presence of gas bubbles by comparing the first signal and the second signal.

44. The Coriolis flow meter according to claim 35,
wherein the measuring or operating circuit is configured:
to determine a second measured value representing the process variable as a function of a phase difference Δφ between the filtered first sensor signal s1* or first sensor signal s1 and the second sensor signal s2 and the driver frequency f,
to correct the second measured value as a function of the filter coefficient a or the first measured value, and
to output the corrected second measured value.

45. A Coriolis flow meter for determining a time-varying process variable of a flowable medium, comprising:
a measuring tube for conducting the medium;
an excitation system for inducing mechanical oscillations of the measurement tube;
a sensor system for detecting the mechanical oscillations of the measurement tube,
wherein the sensor system is configured to generate at least a first sensor signal s1 and a second sensor signal s2,
a measuring or operating circuit, in particular formed by means of at least one microprocessor,
wherein the measuring or operating circuit is configured to operate the excitation system with an excitation signal,
wherein the measuring or operating circuit comprises a first adaptive filter with a filter coefficient a, which is configured to receive the first sensor signal s1 and to generate a filtered first sensor signal s1*,
wherein the measuring or operating circuit comprises a second adaptive filter with a filter coefficient b, which is configured to receive the second sensor signal s2 and to generate a filtered second sensor signal s2*,
wherein the measuring or operating circuit comprises a control circuit which is configured to receive the filtered first sensor signal s1* and the filtered second sensor signal s2*, or a variable derived from the filtered first sensor signal s1* and the filtered second sensor signal s2*,
wherein the control circuit is configured to control the filter coefficient a or the filter coefficient b, based upon the filtered first sensor signal s1* and the filtered second sensor signal s2*, or a variable derived from the filtered first sensor signal s1* and the filtered second sensor signal s2*, so that a control criterion is met,
wherein the measuring or operating circuit is configured to generate, from the filter coefficient a or from the filter coefficient b, a first measured value representing the process variable.

46. The Coriolis flow meter according to claim 45,
wherein the control circuit is configured to determine the filter coefficient a or the filter coefficient b by means of a least mean squares algorithm or by means of a normalized least mean squares algorithm or by means of a recursive least squares algorithm or a linear or non-linear gradient method.

47. The Coriolis flow meter according to claim 45,
wherein the control circuit comprises a PID controller which is configured to control the filter coefficient a and the filter coefficient b, based upon the filtered first sensor signal s1* and the filtered second sensor signal s2* or the variable derived from the filtered first sensor signal s1* and the filtered second sensor signal s2*, so that the control criterion is met.

48. The Coriolis flow meter according to claim 45,
wherein the process variable comprises the mass flow of the medium.

49. The Coriolis flow meter according to claim 48,
wherein the excitation signal has a driver frequency,
wherein the driver frequency is not included in the determination of the first measured value representing the mass flow of the medium.

50. The Coriolis flow meter according to claim 49,
wherein the control criterion requires that a deviation between the filtered first sensor signal s1* and the filtered second sensor signal s2* correspond to a sensor signal setpoint or be smaller than a sensor signal limit value.

51. The Coriolis flow meter according to claim 45,
wherein the measuring or operating circuit is configured to determine a phase difference Δφ between the filtered first sensor signal s1* and the filtered second sensor signal s2*,
wherein the derived variable corresponds to the phase difference Δφ.

52. The Coriolis flow meter according to claim 39,
wherein the control criterion comprises that the phase difference Δφ correspond to a phase difference setpoint or to less than a phase difference limit.

53. The Coriolis flow meter according to claim 45,
wherein, additionally, a calibration factor k, which is determined at the factory, is included in the generation of the first measured value representing the process variable.

54. The Coriolis flow meter according to claim 45,
wherein the measuring or operating circuit is configured to determine and optionally output the current process status from the filter coefficient a or from the filter coefficient b.

55. The Coriolis flow meter according to claim 5,
wherein the current process status comprises the presence of gas bubbles in the medium.

56. The Coriolis flow meter according to claim 45,
wherein the measuring or operating circuit is configured:
in a first operating mode, to determine and output a second measured value representing the process variable as a function of a phase difference Δφ between the first sensor signal s1 or the filtered first sensor signal s1* and the filtered second sensor signal s2* and the driver frequency f,
in a second operating mode, to determine and output the first measured value representing the process variable as a function of the filter coefficient a or the filter coefficient b.

57. The Coriolis flow meter according to claim 41,
wherein the measuring or operating circuit is configured to switch from the first operating mode to the second operating mode when a deviation between the first measured value and the second measured value corresponds to a setpoint or lies outside a tolerance range.

58. The Coriolis flow meter according to claim 56,
wherein the measuring or operating circuit is configured to determine the presence of gas bubbles by comparing a signal representing the first measured value and a signal representing the second measured value.

59. The Coriolis flow meter according to claim 45,
wherein the measuring and operating circuit is configured:
to determine a second measured value representing the process variable as a function of a phase difference Δφ between the filtered first sensor signal s1* or first sensor signal s1 and the filtered second sensor signal s2* or second sensor signal s2 and the driver frequency f,
to correct the second measured value as a function of the filter coefficients a or b, or the first measured value, and
to output the corrected second measured value.

60. The Coriolis flow meter according to claim 45,
wherein the first filter is designed such that the mathematical relationship between the first sensor signal s1 and the filtered first sensor signal s1* can be described via a transfer function H(s)=(1−a·s) with a Laplace index s.

61. The Coriolis flow meter according to claim 35,
wherein the first filter is designed such that the mathematical relationship between the first sensor signal s1 and the filtered first sensor signal s1* can be described via a transfer function H(s)=(1−a·s)/(1+as) with a Laplace index s.

62. The Coriolis flow meter according to claim 35,
wherein the first filter is designed such that the mathematical relationship between the first sensor signal s1 and the filtered first sensor signal s1* can be described via a transfer function H(s)=(1+a)/2+(1−a)/2·z⁻¹,
wherein z is a z-variable of a discrete system.

63. The Coriolis flow meter according to claim 45,
wherein the second filter is designed such that the mathematical relationship between the second sensor signal s2 and the filtered second sensor signal s2* can be described via a transfer function H(s)=(1+b·s) with a Laplace index s.

64. The Coriolis flow meter according to claim 45,
wherein the second filter is designed such that the mathematical relationship between the second sensor signal s2 and the filtered second sensor signal s2* can be described via a transfer function H(s)=(1−b)/2+(1+b)/2·z⁻¹,
wherein z is a z-variable of a discrete system.

65. The Coriolis flow meter according to claim 45,
wherein the second filter is designed such that the mathematical relationship between the second sensor signal s2 and the filtered second sensor signal s2* can be described via a transfer function H(s)=½+½*z⁻¹,
wherein z is a z-variable of a discrete system.

66. The Coriolis flow meter according to claim 45,
wherein the second filter is designed such that the mathematical relationship between the second sensor signal s2 and the filtered second sensor signal s2* can be described via a transfer function H(s)=1.

67. The Coriolis flow meter according to claim 35,
wherein a=b must be satisfied.

68. The Coriolis flow meter according to claim 35,
wherein the first adaptive filter or the second adaptive filter, in particular each, is an all-pass filter.
